(19) United States
(12) Patent Application Publication
(10) Pub. No.: US 2026/0368971 A1
(43) Pub. Date: Nov. 19, 2026

(54) VIDEO GENERATION

(71) Applicant: Beijing Zitiao Network Technology Co., Ltd., Beijing (CN)

(72) Inventors: Jiaqi Yang, Beijing (CN); Zhenzhi Wang, Beijing (CN); Chao Liang, Beijing (CN); Jianwen Jiang, Beijing (CN); Gaojie Lin, Beijing (CN); Zerong Zheng, Beijing (CN)

(21) Appl. No.: 19/679,575

(22) Filed: May 15, 2026

(30) Foreign Application Priority Data
May 15, 2025 (CN) 202510627431.9

(51) Int. Cl. G06T 11/60

(52) U.S. Cl. CPC G06T 11/60

(57) ABSTRACT

According to embodiments of the disclosure, a method, an apparatus, a device for video generation, and a storage medium are provided. The method includes: receiving a video generation request, the video generation request being associated with a plurality of reference images corresponding to a plurality of objects, and the video generation request indicating a selection of at least one object from the plurality of objects; and providing video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

### CROSS-REFERENCE

This application claims the benefit of CN Patent Application No. 202510627431.9, filed on May 15, 2025, entitled “METHOD, APPARATUS, DEVICE FOR VIDEO GENERATION, AND STORAGE MEDIUM”, which is incorporated herein by reference in its entirety.

### FIELD

Example embodiments of the present disclosure generally relate to the field of computers, and in particular, to video generation.

### BACKGROUND

With the development of computer technologies, some machine learning technologies support users to drive images through control signals, thereby generating dynamic video content. For example, a user may drive a digital human to perform actions corresponding to an audio signal by inputting the audio signal.

### SUMMARY

In a first aspect of the present disclosure, a method for video generation is provided. The method includes: receiving a video generation request, the video generation request being associated with a plurality of reference images corresponding to a plurality of objects, and the video generation request indicating a selection of at least one object from the plurality of objects; and providing video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

In a second aspect of the present disclosure, an apparatus for video generation is provided. The apparatus includes: a request receiving module and a video providing module. The request receiving module is configured to receive a video generation request, the video generation request being associated with a plurality of reference images corresponding to a plurality of objects, and the video generation request indicating a selection of at least one object from the plurality of objects; and the video providing module is configured to provide video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

In a third aspect of the present disclosure, an electronic device is provided. The electronic device includes at least one processor; and at least one memory, the at least one memory being coupled to the at least one processor and storing instructions for execution by the at least one processor, the instructions, when executed by the at least one processor, causing the electronic device to perform the method of the first aspect.

In a fourth aspect of the present disclosure, a non-transitory computer-readable storage medium is provided. The non-transitory computer-readable storage medium has a computer program stored thereon, the computer program being executable by a processor to implement the method of the first aspect.

In a fifth aspect of the present disclosure, a computer program product is provided. The computer program product is tangibly stored in a computer storage medium and includes computer-executable instructions that, when executed by a device, cause the device to perform the method of the first aspect.

It should be understood that the content described in the Summary section of the present disclosure is not intended to identify key or essential features of the embodiments of the present disclosure, nor is it intended to limit the scope of the present disclosure. Other features of the present disclosure will become readily comprehensible through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numerals represent the same or similar elements, where:

FIG. 1 illustrates a schematic diagram of an example environment in which the embodiments according to the present disclosure may be implemented;

FIG. 2A to FIG. 2C illustrate schematic diagrams of data preprocessing according to some embodiments of the present disclosure;

FIG. 3 illustrates an example structure of a video generation model according to some embodiments of the present disclosure;

FIG. 4 illustrates a flowchart of an example process of video generation according to some embodiments of the present disclosure;

FIG. 5 illustrates a schematic structural block diagram of an example apparatus for video generation according to some embodiments of the present disclosure; and

FIG. 6 illustrates a block diagram of an electronic device capable of implementing a plurality of embodiments of the present disclosure.

### DETAILED DESCRIPTION OF EMBODIMENTS

The embodiments of the present disclosure will be described in more detail below with reference to the drawings. Although certain embodiments of the present disclosure are shown in the drawings, it should be understood that the present disclosure may be implemented in various forms, and should not be construed as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be noted that the titles of any section/subsection provided herein are not restrictive. Various embodiments are described throughout this article, and any type of embodiment may be included under any section/subsection. In addition, the embodiments described in any section/subsection may be combined with any other embodiments described in the same section/subsection and/or different section/subsection in any manner.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or same objects. Other explicit and implicit definitions may also be included below.

The embodiments of the present disclosure may involve user data, data acquisition, and/or data use, etc. These aspects all follow the corresponding laws, regulations, and related provisions. In the embodiments of the present disclosure, all data collection, acquisition, processing, machining, forwarding, use, etc. are performed on the premise that the user is aware of and confirms. Accordingly, when implementing the embodiments of the present disclosure, the user should be informed of the type, range of use, use scenarios, etc., of possible involved data or information, and the authorization of the user should be obtained, in an appropriate manner according to relevant laws and regulations. The specific manner of informing and/or authorizing may vary according to the actual situation and application scenarios, and the scope of the present disclosure is not limited in this regard.

If the solutions in this specification and the embodiments involve personal information processing, the processing will be performed on the premise that there is a legal basis (for example, the consent of the personal information subject is obtained, or it is necessary to perform a contract, etc.), and the processing will only be performed within a specified or agreed scope. If the user refuses to process personal information other than the necessary information required for the basic functions, it will not affect the user's use of the basic functions.

The video generation technology of audio-driven portrait aims to drive a portrait image with a clip of speech audio. In recent years, although continuous progress has been made in this field, related technologies often focus on single-person scenarios. Generally speaking, related solutions need to perform pre-processing of determining the number of persons before model processing, so as to ensure that the input image only contains a single person, and the model uses the input single-person image and audio to generate a clip of person speaking video.

However, in practical use, users may face an unavoidable requirement: the input image contains multiple persons, and a specific person needs to be driven, instead of multiple persons in the image speaking at the same time. For a model of a multi-person scenario, in addition to the design of the model architecture, a large amount of target data also needs to be collected, both of which are extremely time-consuming and labor-intensive.

In the related technologies of multi-person scenarios, driving a specific person to speak based on a large amount of data is not only time-consuming and labor-intensive, but also often only the mouth shape or face of the person may be driven, and it is difficult to accurately predict and drive the actions of each person, resulting in the single picture content in the generated video content, or the difficulty in adapting the audio content corresponding to the speaker to the motion content in the picture.

Embodiments of the present disclosure provides a solution for video generation. The solution includes: receiving a video generation request, the video generation request being associated with a plurality of reference images corresponding to a plurality of objects, and the video generation request indicating a selection of at least one object from the plurality of objects; and providing video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

The embodiments of the present disclosure are capable of generating, based on a plurality of reference images corresponding to a plurality of objects and a selection of at least one object from the plurality of objects, object content corresponding to the plurality of objects and background content matching the object content, in combination with audio content, with the object content presenting motion content of the selected object(s) adapted to the audio content. In this way, the embodiments of the present disclosure are not only capable of pinpointing an effective speaking object in a multi-object scenario, to quickly generate object content of a specified person speaking, thereby effectively ensuring the correlation and accuracy between the motion content in the video content and the selected object(s), but are also capable of generating corresponding background content, and ensuring the adaptability between the background content and the multi-object scenario and audio content, thereby ensuring the correlation and adaptability between the background content and the object content, and in turn ensuring the generation efficiency and content quality of the generated video content.

Various example implementations of the solution will be described in detail below in further combination with the drawings.

### EXAMPLE ENVIRONMENT

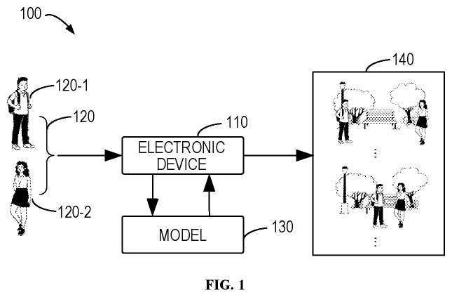

FIG. 1 illustrates a schematic diagram of an example environment 100 in which the embodiments of the present disclosure may be implemented. As shown in FIG. 1, the example environment 100 may include an electronic device 110.

Referring to FIG. 1, the electronic device 110 may obtain a plurality of reference images 120 corresponding to a plurality of objects, for example, the plurality of reference images 120 may include at least a first reference image 120-1 corresponding to a first object and a second reference image 120-2 corresponding to a second object.

As an example, the plurality of objects may include objects that may generate dynamic content, such as persons, animals, etc., for example, two or more persons or animals, etc. The plurality of objects may include virtual objects identified from images corresponding to entity objects such as persons or animals, and may also include fictitious virtual objects, such as cartoon characters or animals.

In some embodiments, the plurality of reference images 120 obtained by the electronic device 110 may include a plurality of independent reference images input by the user, for example, a plurality of reference images in a one-to-one correspondence with a plurality of virtual objects.

In some embodiments, the plurality of reference images 120 obtained by the electronic device 110 may also include a subject image corresponding to at least one subject identified from an image input by the user.

As an example, the input image may include a plurality of objects of a preset type, such as a plurality of persons or a plurality of animals that may make sounds. The electronic device 110 may invoke a preset recognition algorithm or recognition model to identify the plurality of objects in the input image, thereby obtaining a plurality of reference images corresponding to the plurality of objects.

In some embodiments, the electronic device 110 may also obtain specified information corresponding to the plurality of reference images 120. As an example, the obtained specified information may indicate that the object corresponding to the first reference image 120-1 or the second reference image 120-2 is used as a specified object. For example, the specified object may be used as a speaking object or an object making an action in the generated video content 140.

As an example, the electronic device 110 may distinguish a speaking object (speaker) and a non-speaking object (listener) among the plurality of objects based on the specified information, or distinguish an object making an action and an object watching quietly.

As an example, the electronic device 110 may receive a specified identification for at least one reference image from the plurality of reference images 120, as specified information for at least one object corresponding to the at least one reference image, so as to use the at least one object as a specified object.

As an example, in the case that the electronic device 110 identifies the plurality of reference images from the input image, the electronic device 110 may present a plurality of indication elements (such as identification boxes, etc.) corresponding to the plurality of objects after identifying the plurality of objects, and then receive selection information for at least one indication element from the plurality of indication elements, to determine the specified information for at least one object from the plurality of objects.

In some embodiments, the electronic device 110 may generate or receive a corresponding video generation request based on the plurality of reference images obtained and the specified information described above.

In some embodiments, the electronic device 110 may also obtain at least one piece of reference content (not shown in the figure) corresponding to the plurality of reference images 120. As an example, the reference content may include at least one of text content, voice content, video content, and the like. The electronic device 110 may drive at least one object from the plurality of objects based on the obtained reference content, to generate video content of the specified object speaking.

In some embodiments, the voice content in the reference content may be voice content determined based on multimedia content, such as audio content, video content, etc., uploaded by the user, or may be voice content determined based on text content uploaded by the user.

As an example, the electronic device 110 may obtain, based on the obtained audio content, motion content corresponding to the specified object making the audio content, in combination with the reference image corresponding to the specified object, thereby obtaining picture content that drives the specified object to speak.

In some embodiments, the electronic device 110 may generate or receive a corresponding video generation request based on the plurality of reference images 120, the specified information, and the reference content obtained, and generate corresponding video content accordingly.

As will be described in detail below, the electronic device 110 may provide the plurality of reference images 120 having the plurality of objects, specified information for the at least one object, and the obtained reference content, to the pre-trained model 130, to generate the video content 140.

As an example, the electronic device 110 may determine image features corresponding to the plurality of reference images 120 based on the plurality of reference images 120, including object features corresponding to the plurality of objects, such as an object feature corresponding to the specified object, and object features corresponding to other objects other than the specified object.

Further, the electronic device 110 may use the model 130 to generate object content corresponding to the plurality of objects based on the object features corresponding to the plurality of objects. As an example, the object content corresponds to the received reference content in a plurality of modalities. For example, the model 130 may be a pre-trained generation model.

In this solution, the object content may include head movement, such as movement of the mouth and/or face, generated based on the reference content, and may also include body movement generated based on skeleton information of reference video content, for example, at least one of walking, riding, standing up/sitting down, turning around, making at least one gesture, etc.

In some embodiments, the generated object content may include motion content associated with the specified object, such as mouth shape action content, face action content, head action content, etc., corresponding to the specified object speaking, and further such as position movement content of the specified object marching, rising/sitting, turning around, etc. As an example, the specified object corresponds to the specified object selected from the plurality of objects.

In some embodiments, the generated object content may also include motion content associated with other objects other than the specified object, such as position movement content of the other objects marching, rising/sitting, turning around, etc.

In this solution, the electronic device 110 may not only generate the object content corresponding to the plurality of objects, but also generate background content adapted to the plurality of objects and the reference content.

In some embodiments, the electronic device 110 may use the model 130 to generate corresponding background content based on the obtained plurality of reference images 120 and the reference content.

As an example, if the electronic device 110 obtains the plurality of reference images 120 based on the input image, the electronic device 110 may also determine scene features corresponding to the plurality of objects based on the input image.

As an example, the electronic device 110 may determine the scene features corresponding to the plurality of objects based on the object features corresponding to the plurality of objects respectively, in combination with the obtained reference content.

In some embodiments, the electronic device 110 may generate a corresponding background image or scene feature based on the text content in the obtained reference content.

The electronic device 110 may fuse the generated scene features or background images with the object content corresponding to the plurality of objects, to obtain the video content 140 including the object content and the scene content.

As shown in FIG. 1, the video content 140 may include a plurality of video frame sequences. As an example, the electronic device 110 may separately generate an object content sequence corresponding to the object features of the plurality of objects and a background content sequence corresponding to the scene features, and fuse the two to obtain the plurality of video frame sequences; and then sort the plurality of video frame sequences according to a preset order and a preset time interval, to obtain the video content 140.

In some embodiments, the electronic device 110 may determine a plurality of image features corresponding to the plurality of reference images 120 based on the plurality of reference images 120, and determine a first mask corresponding to the selected at least one object from the plurality of objects; and then generate the video content 140 based on the plurality of image features, the first mask, and the obtained reference content (for example, audio content). As an example, the electronic device 110 may invoke a preset generation algorithm or the pre-trained model 130 to process the plurality of image features, the first mask, and the audio content for driving the speaker, thereby obtaining the generated video content 140.

In some embodiments, the electronic device 110 may determine the first mask corresponding to the at least one object based on a video token of reference video and an object token corresponding to the at least one object. As an example, the electronic device 110 may invoke a mask unit to process the video token and the object token to determine the first mask corresponding to the at least one object from the plurality of objects.

For example, the electronic device 110 may first obtain the reference video and then determine the corresponding video token based on the reference video, or may directly obtain a preset video token. For example, the electronic device 110 may perform processing such as encoding on the reference video to obtain the corresponding video token.

As an example, the reference video obtained by the electronic device 110 may be a reference video input by the user, or may be a reference video obtained by the electronic device 110 from a preset database or cloud based on a preset operation.

As an example, the video token may indicate a subject dynamic feature corresponding to at least one subject in the reference video, such as a head dynamic feature, such as a mouth or face of the subject, and further such as a limb dynamic feature of the subject.

In some embodiments, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including the accessories and peripherals of these devices, or any combination thereof. In some embodiments, the electronic device 110 may also support any type of user-specific interface (such as “wearable” circuitry, etc.).

In some embodiments, the electronic device 110 may also invoke a server (not shown in the figure) to process the received video generation request based on tools such as the server or a model configured in the server, thereby obtaining the generated video content.

The server may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server may include, for example, a computing system/server, such as a mainframe, an edge computing node, a computing device in a cloud environment, and so on.

A communication connection may be established between the server and the electronic device 110. The communication connection may be established in a wired or wireless manner. The communication connection may include, but is not limited to, a Bluetooth connection, a mobile network connection, a Universal Serial Bus (USB) connection, a Wireless Fidelity (WiFi) connection, etc., and the embodiments of the present disclosure are not limited in this regard. In the embodiments of the present disclosure, the server and the electronic device 110 may implement signaling interaction through the communication connection therebetween.

It should be understood that the structure and function of each element in the environment 100 are described only for illustrative purposes, without suggesting any limitation on the scope of the present disclosure.

Some example embodiments of the present disclosure will be described below with continued reference to the drawings.

### EXAMPLE DATA PROCESSING PROCESS

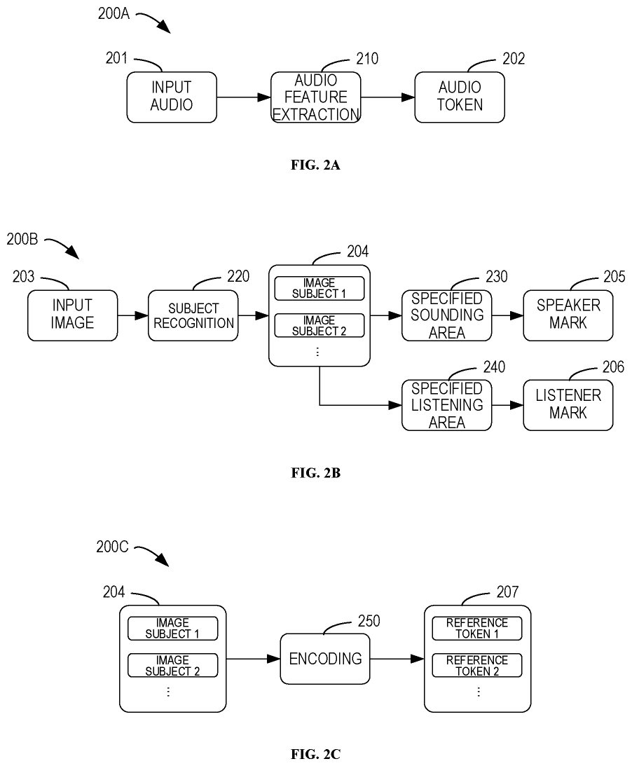

FIG. 2A to FIG. 2C illustrate data preprocessing processes 200A to 200C according to some embodiments of the present disclosure. The processes 200A to 200C may be provided by the electronic device 110 shown in FIG. 1, for example.

In the solution of the embodiments of the present disclosure, the data processed through the processes 200A to 200C may be applied to a pre-trained model or a preset data processing algorithm may be invoked to generate the video content 140.

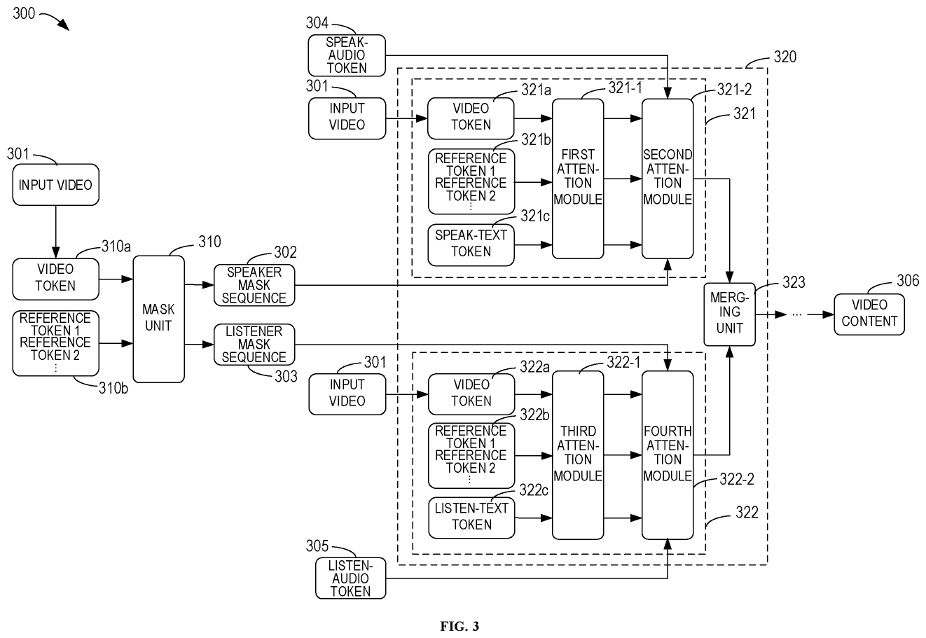

Referring to FIG. 2A, the electronic device 110 may perform audio feature extraction (210) on input audio 201 to obtain a corresponding audio token 202. As an example, the electronic device 110 may extract an audio feature for the input audio 201 to obtain an audio token corresponding to a specified speaker, such as the “speak-audio token” 220 shown in FIG. 3.

In some embodiments, the input audio 201 may be first audio content determined based on media content such as voice content or video content uploaded by the user, or may be second audio content generated based on text content uploaded by the user.

Referring to FIG. 2B, the electronic device 110 may also perform subject recognition (220) on an input image 203 to identify a plurality of subject objects in the input image 203, to obtain a plurality of image subjects 204. For example, the plurality of image subjects 304 may include at least image subject 1, image subject 2, and so on. As an example, the plurality of image subjects 204 may include objects of a predetermined type in the image that are suitable for audio driving, such as persons, animals, etc.

As an example, the electronic device 110 may also directly obtain or receive the plurality of image subjects 204 in a one-to-one correspondence with a plurality of objects. For example, the plurality of image subjects 204 may correspond to the plurality of reference images 120 shown in FIG. 1.

In some embodiments, the electronic device 110 may also receive a selection or specification of at least one image subject from the plurality of image subjects 204 to determine a specified sounding area (230), thereby obtaining a corresponding speaker mark 205; and determine an area corresponding to an image subject other than the specified image subject as a specified listening area (240), thereby obtaining a listener mark 206.

As an example, the electronic device 110 may also receive a selection or specification of at least one dynamic area to specify the listening area (240), thereby obtaining the listener mark 206; and determine an area corresponding to an image subject other than the specified image subject as the specified sounding area (230), thereby obtaining the corresponding speaker mark 205.

As an example, the speaker mark 205 may correspond to a head area or a face area, and/or a limb area, etc., of the specified object from the plurality of objects corresponding to the plurality of reference images 120. The listener mark 206 may correspond to a position area where other objects other than the specified object are located among the plurality of objects.

Referring to FIG. 2C, the electronic device 110 may also perform an encoding (350) operation on the plurality of image subjects 304 to obtain a plurality of subject tokens 207 corresponding to the plurality of object subjects.

As an example, the plurality of subject tokens 207 may include at least reference token 1 corresponding to image subject 1, reference token 2 corresponding to image subject 2, and so on.

In some embodiments, the plurality of subject tokens 207 may indicate a plurality of image features corresponding to the plurality of reference images. For example, reference token 1 may indicate an image feature corresponding to image subject 1, reference token 2 may indicate an image feature corresponding to image subject 2, and so on.

In some embodiments, the electronic device 110 may also obtain an input reference video and determine a corresponding video token based on the input reference video.

As an example, the video token may indicate a subject dynamic feature corresponding to at least one subject in the reference video, such as a head dynamic feature, such as a mouth or face of the subject, and further such as a limb dynamic feature of the subject.

FIG. 3 illustrates an example model 300 for generating a video according to some embodiments of the present disclosure. The specific process of generating video content by the model 300 will be described below with reference to FIG. 3. As an example, the model 300 may be a generative model. In some embodiments, the model 300 may include a mask unit 310.

As shown in FIG. 3, the electronic device 110 may obtain an input video 301, and perform processing such as encoding on the input video 301 to obtain a corresponding video token 310a.

In some embodiments, the electronic device 110 may use the video token 310a and a plurality of subject tokens 310b corresponding to the plurality of image subjects as inputs to the mask unit 310, to obtain a first mask corresponding to at least one object from the mask unit 310. As an example, for the plurality of subject tokens 310b, reference may be made to the plurality of subject tokens 207 obtained by processing in the process 200C.

In some embodiments, the first mask may include a speaker mask sequence 302 corresponding to a speaking subject. As an example, the mask unit 310 may determine a mask corresponding to the speaking subject based on a video feature and an image feature corresponding to the speaking subject. For example, the mask may indicate a position of the speaking subject in a corresponding image frame. In the case that a plurality of speaking subjects are included, the first mask may correspond to, for example, a union of masks corresponding to the plurality of speaking subjects.

By predicting the mask of each subject during the processing of the video model, the embodiments of the present disclosure may support presenting the position change of the subject in the video content, without fixing the subject in the preset area of the video.

Based on this manner, the object content generated by the model may present a second movement associated with one or more objects of the plurality of objects, where the second movement indicates a position change of the one or more objects in the scene. For example, by outputting a mask corresponding to the speaking object frame by frame, the video content may present a second movement of the speaking object, for example, the speaking object moves from a left area of the video to a right area of the video.

In some embodiments, the mask unit 310 may be implemented based on a transformer, which may be trained based on a training video, for example, so that the mask unit 310 may output mask information of a corresponding subject based on a video feature and an image feature.

Referring to FIG. 3, the model 300 may also include a plurality of processing layers 320. The output of the previous processing layer may be used as the input of the next processing layer, and the output of the last processing layer is used as the output of the model 300, that is, the generated video content 306.

In some embodiments, each processing layer 320 may include a first attention unit 321, a second attention unit 322, and a merging unit 323. The first attention unit 321 may be used to generate a first video feature, such as a video feature corresponding to a speaker; the second attention unit 322 may be used to generate a second video feature, such as a video feature corresponding to a listener (non-speaker); and the merging unit 323 is used to merge the first video feature and the second video feature to generate an input video feature of the next processing layer or the generated video content 306.

In some embodiments, the first attention unit 321 is configured to determine a first video feature based on the first mask, the plurality of image features, the audio content, and preset first prompt information. The plurality of image features may be object features corresponding to at least one specified speaking object from the plurality of objects. Accordingly, the first video feature may be a video feature corresponding to the at least one speaking object.

As an example, the first mask may at least indicate position information of the specified speaking object in a picture corresponding to the video content. For example, the first mask may include head position information, such as a mouth shape and a face, and body position information, etc., of the specified speaking object in the picture at different times of the video content. As an example, the first mask may be a speaker mask sequence 302 corresponding to the specified speaking object in different timing pictures.

As an example, the electronic device 110 may encode the plurality of reference images 120 or the plurality of image subjects 204 to obtain a plurality of image features corresponding to the plurality of objects. For example, the electronic device 110 may obtain an image feature corresponding to the specified speaker by encoding a reference image or an image subject corresponding to the specified object. As an example, the plurality of image features may be a plurality of reference tokens 321b corresponding to the plurality of objects (or the at least one speaking object).

As an example, the electronic device 110 may perform encoding processing on the audio content to obtain a speak-audio token 304 corresponding to the specified speaking object. For example, reference may be made to the process 200A.

As an example, the electronic device 110 may obtain a speak-text token 321c corresponding to the specified speaking object based on the preset first prompt information. For example, the first prompt information may be “this subject is speaking”, etc.

Referring to FIG. 3, the first attention unit 321 may include a first attention module 321-1 and a second attention module 321-2. As an example, the first attention module 321-1 may have three input channels, and the output of the first attention module 321-1 corresponds to at least part of the input of the second attention module 321-2. The first input channel of the first attention module 321-1 may correspond to an input video feature.

As an example, the first attention module 321-1 may be a multimodal attention module, and the second attention module 321-2 may be a cross-attention module.

In some embodiments, the model 300 may be a generative model based on a diffusion model. Accordingly, the electronic device 110 may obtain a video token 321a by encoding the input video 301, as input information for the first input channel of the first attention module 321-1. The video token 321a corresponds to a dynamic feature of a speaker in the input video 301, such as a head movement feature such as a mouth or a face, and for another example, a body movement feature determined based on a bone or the like.

In some embodiments, the electronic device 110 may also superimpose preset noise on the video token 321a, which is then used as input information for the first input channel of the first attention module 321-1.

In some embodiments, the input video 301 may include other video content associated with the to-be-generated video content. As an example, the input video 301 may be a reference video uploaded by the user, may be a video or a video feature output by the previous processing layer 320, or may be part of video frames in a previous video clip that is continuous in time.

In some embodiments, the second input channel of the first attention module 321-2 may correspond to an input image feature.

As an example, the input image feature may include a plurality of reference tokens 321b determined by encoding the plurality of reference images 120 or the plurality of image subjects 204. For example, the reference tokens 321b may correspond to at least one selected object from the plurality of corresponding objects in the plurality of reference images 120 or the plurality of image subjects 204.

In some embodiments, the third input channel of the first attention module 321-2 may correspond to an input text feature.

As an example, in the case that the reference content obtained by the electronic device 110 includes reference text content (for example, a prompt), the input text feature may include a speak-text token 321c determined by encoding the reference text content. For example, “this person is speaking”.

In some embodiments, depending on the content type corresponding to the reference content, the first attention module 321-1 may perform an attention mechanism-based update process on at least two types of input features received via the plurality of input channels. For example, in the case that the reference content includes input video content, the first attention module 321-1 may update the input video feature (for example, the video token 321a) and the input image feature (for example, the plurality of reference tokens 321b) based on a multimodal attention mechanism.

Referring to FIG. 3, the second attention module 321-2 includes a plurality of input channels. As an example, in addition to part of the input channels corresponding to the output channel of the first attention module 321-1, the second attention module 321-2 may further include a fourth input channel and a fifth input channel.

In some embodiments, the fourth input channel may correspond to an input audio feature, and the fifth input channel may correspond to an input image feature.

In some embodiments, the fourth input channel may correspond to a speak-audio token 304 obtained by encoding based on input audio content. The speak-audio token 304 corresponds to an audio feature corresponding to a specified speaker in the input audio content.

As an example, in the case that the obtained reference content includes audio content, the electronic device 110 may determine an audio feature of the input audio content. As an example, the audio feature may include a Mel spectrogram feature of the audio content. Further, an encoding unit may be used to process the audio feature to obtain the corresponding speak-audio token 304. As an example, the encoding unit may include, for example, a Multilayer Perceptron (MLP) or other appropriate models.

In some embodiments, the fifth input channel may correspond to the speaker mask sequence 302 output by the mask unit 310. As an example, the speaker mask sequence 302 may be an indication element for the at least one selected speaking object from the plurality of objects in the picture of the video content, for example, corresponding to a contour identification of the at least one speaking object in different timing pictures of the to-be-generated video content, etc.

In some embodiments, the second attention module 321-2 may update the input video feature based on a cross-attention mechanism and based on the speak-audio token 304 and the speaker mask sequence 302, to obtain the first video feature corresponding to the speaker.

In some embodiments, the second attention unit 322 is configured to determine a second video feature based on a second mask, the plurality of image features, and preset second prompt information. As an example, the plurality of image features may be object features corresponding to other objects than the specified speaking object from the plurality of objects, that is, object features corresponding to the non-speaking object. Accordingly, the second video feature may be a second video feature corresponding to other objects than the specified speaker.

As an example, the second mask may at least indicate position information of other objects (that is, non-speaking objects) than the specified speaker in the picture corresponding to the video content. For example, the second mask may include position information, such as a head and a limb, of the non-speaking object in the picture at different times of the video content. As an example, the second mask may be a listener mask sequence 303 corresponding to the non-speaking object in different timing pictures. In some examples, the second mask may be determined based on the first mask, for example, the second mask may indicate other areas in the image than the target area indicated by the first mask.

As an example, the electronic device 110 may encode the plurality of reference images 120 or the plurality of image subjects 204 to obtain a plurality of image features corresponding to the non-speaking object. For example, the electronic device 110 may encode a reference image or an image subject corresponding to other objects than the specified object from the plurality of objects, to obtain an image feature corresponding to the non-speaking object. As an example, the plurality of image features here may be reference tokens 322b corresponding to the plurality of objects (or non-speaking objects).

As an example, the electronic device 110 may obtain a listen-text token 322c corresponding to other objects than the specified speaking object based on the preset second prompt information. For example, the second prompt information may be “this subject is listening” or “this subject is not speaking”, etc.

Continuing to refer to FIG. 3, the second attention unit 322 may include a third attention module 322-1 and a fourth attention module 322-2. As an example, the third attention module 322-1 may have three input channels, and the output of the third attention module 322-1 corresponds to at least part of the input of the fourth attention module 322-2. The first input channel of the third attention module 322-1 may correspond to the input video feature.

As an example, the third attention module 322-1 may be a multimodal attention module, and the fourth attention module 322-2 may be a cross-attention module.

In some embodiments, the electronic device 110 may obtain a video token 322a by encoding the input video 301, as input information for the first input channel of the third attention module 322-1. As an example, the video token 322a may correspond to a video feature corresponding to the non-speaking object in the input video 301.

In some embodiments, the electronic device 110 may also superimpose preset noise on the video token 322a, which is then used as input information for the first input channel of the third attention module 321-1.

In some embodiments, the input video 301 may include other video content associated with the to-be-generated video content. As an example, the input video 301 may be a reference video uploaded by the user, may be a video or a video feature output by the previous processing layer 320, or may be part of video frames in a previous video clip that is continuous in time.

In some embodiments, the second input channel of the third attention module 322-2 may correspond to an input image feature.

As an example, the input image feature may include a plurality of reference tokens 322b determined by encoding the plurality of reference images 120 or the plurality of image subjects 204. For example, the plurality of reference tokens 322b may correspond to other objects than the specified speaking object in the plurality of reference images 120 or the plurality of image subjects 204.

In some embodiments, the third input channel of the third attention module 322-2 may correspond to an input text feature.

As an example, in the case that the reference content obtained by the electronic device 110 includes reference text content (for example, a prompt), the input text feature may include a listen-text token 322c determined by encoding the reference text content. For example, “this person is listening”.

In some embodiments, depending on the content type corresponding to the reference content, the third attention module 322-1 may perform an attention mechanism-based update process on at least two types of input features received via the plurality of input channels. For example, in the case that the reference content includes input video content, the third attention module 322-1 may update the input video feature (for example, the video token 322a) and the input image feature (for example, the reference tokens 322b) based on a multimodal attention mechanism.

Referring to FIG. 3, the fourth attention module 322-2 includes a plurality of input channels. As an example, in addition to part of the input channels corresponding to the output channel of the third attention module 322-1, the fourth attention module 322-2 may further include a fourth input channel and a fifth input channel.

In some embodiments, the fourth input channel corresponding to the fourth attention module 322-2 may correspond to an input audio feature, and the fifth input channel may correspond to an input image feature.

In some embodiments, the fourth input channel corresponding to the fourth attention module 322-2 may correspond to a listen-audio token 305 obtained by encoding based on input audio content. As an example, the input audio content corresponding to the listen-audio token 305 may be a silent audio clip or empty.

In some embodiments, the fifth input channel corresponding to the fourth attention module 322-2 may correspond to a listener mask sequence 303 obtained by identifying and marking based on an input image. As an example, the listener mask sequence 303 may be an indication element for other objects than the at least one specified object from the plurality of objects in the picture of the to-be-generated video content, for example, a contour identification of each non-speaking object in different timing pictures of the to-be-generated video content, etc.

In some embodiments, the fourth attention module 322-2 may update the input video feature based on a cross-attention mechanism and based on the listen-audio token 305 and the listener mark 302, to obtain the second video feature corresponding to the listener.

As shown in FIG. 3, the merging unit 323 includes two input channels, which correspond to the output channel of the first attention unit 321 and the output channel of the second attention unit 322, respectively.

In some embodiments, the merging unit 323 merges the first video feature output by the first attention unit 321 and the second video feature output by the second attention unit 322 to generate an input video feature for the next processing layer 320.

In this way, after iteratively processing by the plurality of processing layers 320, the model 300 may output a final video feature to generate the video content 306.

Accordingly, in the case of receiving a video generation request, the electronic device 110 may control the video driving process based on the content type of the obtained reference content, using feature injection modes corresponding to different types of control signals.

In some embodiments, a video content with a longer duration may also be generated by using a segmentation manner. Specifically, a first video clip generated by the video generation model based on the image feature and the control feature may be obtained. As an example, the first video clip may have a preset duration, for example. In some embodiments, when generating the first video clip, the video tokens 321a and 322a may be set to be empty, for example.

Further, the first video clip may be further used to generate a subsequent second video clip. As an example, the second video clip may also have a preset event duration. Specifically, a reference video feature may be determined based on a plurality of video frames in the first video clip. The reference video feature may include, for example, video tokens 321a and 322a determined based on the plurality of video frames.

Further, the electronic device 110 may provide the image feature, the audio feature, and the reference video feature to the video generation model to generate the second video clip. That is, in the process of generating a subsequent video clip, an original reference image may be provided. Therefore, the embodiments of the present disclosure may further improve the consistency of the video content while ensuring the continuity of video writing.

Further, the electronic device 110 may generate a target video based on the generated first video clip and the generated second video clip. Specifically, the target video may be generated by mixing an overlapped portion of the first video clip and the second video clip. In some embodiments, because the second video clip is generated based on part of the video frames in the first video clip, the consistency and continuity of the generated video content may be ensured. In addition, an injection timing smoothing technique may be used at the overlapped portion of the two videos to eliminate a jumping phenomenon.

In this way, the embodiments of the present disclosure may generate a continuous video content with a longer duration based on the reference image.

As described above, the embodiments of the present disclosure are capable of generating video content based on the plurality of reference images corresponding to the plurality of objects and the specified information for the at least one object, where the video content is not only capable of distinguishing speaking objects from non-speaking objects to generate object content of audio driving objects speaking, but is also capable of generating matching background content, thereby effectively ensuring the content richness and accuracy of the video content, and ensuring the generation efficiency of the video content.

### EXAMPLE VIDEO GENERATION PROCESS

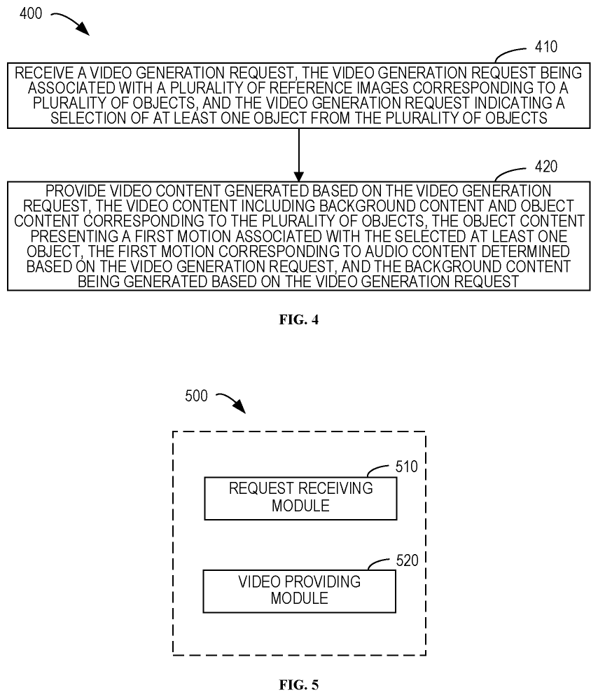

FIG. 4 illustrates a flowchart of an example process 400 of video generation according to some embodiments of the present disclosure. The process 400 may be implemented at the electronic device 110. The process 400 will be described below with reference to FIG. 1.

As shown in FIG. 4, at block 410, the electronic device 110 receives a video generation request, the video generation request being associated with a plurality of reference images corresponding to a plurality of objects, and the video generation request indicating a selection of at least one object from the plurality of objects.

As an example, the plurality of reference images may be the plurality of reference images 120 in FIG. 1 or the plurality of subject images 204 in FIG. 2B and FIG. 2C.

At block 420, the electronic device 110 provides video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

As an example, for the video content, reference may be made to the video content 140 shown in FIG. 1 or the video content 306 shown in FIG. 3.

The embodiments of the present disclosure are capable of quickly generating, based on a selection of at least one object from a plurality of objects and reference images corresponding to the plurality of objects, video content in combination with audio content, where the video content includes motion content associated with the at least one object and object content corresponding to other objects, and also includes background content adapted to the audio content. That is, this solution is capable of generating, based on a selection of a target object from the plurality of objects, video content with the target object as a speaker in combination with the audio content, and generating matching background content. In this way, the embodiments of the present disclosure are capable of quickly generating the video content, and ensuring the correlation and accuracy between the object content in the generated video content and the selected object(s) and audio content; and are also capable of improving the richness of the video content by generating the background content, thereby ensuring the video generation efficiency and the content quality of the generated video content.

In some embodiments, the object content also presents a second motion associated with one or more objects of the plurality of objects, the second motion indicating a position change of the one or more objects in the scene.

In this way, the embodiments of the present disclosure are capable of presenting the position change of the object(s) in the scene in the generated video content, thereby enhancing the dynamic effect of the video content and ensuring the richness of the generated video content.

In some embodiments, the video generation request indicates that the selected at least one object is a speaking object.

In this way, the embodiments of the present disclosure are capable of determining that the specified object is the speaking object in the process of receiving the video generation request, thereby effectively ensuring the accuracy of the speaking object in the generated video content and thus ensuring the accuracy of the video content.

In some embodiments, the background content is generated based on first text content indicated by the video generation request.

In this way, the embodiments of the present disclosure are capable of generating the background content based on the text content indicated by the video generation request, thereby effectively ensuring the accuracy and effectiveness of the background content in the video content.

In some embodiments, the process 400 also includes: the electronic device 110 obtains a target image associated with the video generation request; identifies the plurality of objects from the target image to determine a plurality of areas corresponding to the plurality of objects; and determines the plurality of reference images corresponding to the plurality of areas from the target image.

In this way, the embodiments of the present disclosure are capable of identifying the plurality of reference images corresponding to the plurality of objects from the obtained group image, thereby effectively expanding the acquisition channels of the plurality of reference images, expanding the types of input images, enriching the generation basis of the video content, and improving the interaction experience.

In some embodiments, the audio content includes: first audio content determined based on uploaded media content; or second audio content generated based on text content indicated by the video generation request.

In this way, the embodiments of the present disclosure may generate the audio content based on the media content or the text content, and generate the motion content associated with the selected object accordingly, thereby effectively expanding the source content type of the audio content and providing convenience for users.

In some embodiments, the video content is generated based on the following process: the electronic device 110 determines a plurality of image features corresponding to the plurality of reference images; determines a first mask corresponding to the at least one object; and generates, by a video generation model, the video content based on the plurality of image features, the first mask, and the audio content.

In this way, the embodiments of the present disclosure are capable of generating the video content based on the plurality of image features corresponding to the plurality of reference images and the mask feature of the selected object, in combination with the audio content, which may effectively ensure the matching between the audio content and the selected object, thereby ensuring the accuracy of the specified speaker in the generated video content and ensuring the content quality of the video content.

In some embodiments, determining the first mask corresponding to the at least one object includes: obtaining a video token and an object token corresponding to the at least one object; and determining, by a mask unit, the first mask corresponding to the at least one object based on the video token and the object token.

In this way, by invoking the mask unit to process the video token and the object token, the embodiments of the present disclosure may effectively ensure the efficiency and accuracy of determining the mask feature corresponding to the selected object.

In some embodiments, determining the first mask corresponding to the at least one object also includes: updating, by the video generation model, the video token and the object token; and updating, by the mask unit, the first mask corresponding to the at least one object based on the updated video token and the updated object token.

In this way, the embodiments of the present disclosure are capable of updating the video token and the object token using the video generation model, and updating the mask feature of the object using the mask unit accordingly, so that the mask sequence corresponding to the selected object at different timing positions may be obtained, and then the position information of the selected object in different timing pictures of the video content may be updated, thereby effectively ensuring the real-time performance and variability of the object position in the generated video content, and ensuring the dynamic performance, content accuracy, and richness of the video content.

In some embodiments, the video generation model includes a plurality of processing layers, each processing layer includes a first attention unit, a second attention unit, and a merging unit, where the first attention unit is configured to: determine a first video feature based on the first mask, the plurality of image features, the audio content, and preset first prompt information; the second attention unit is configured to: determine a second video feature based on a second mask, the plurality of image features, and preset second prompt information, the second mask being determined based on the first mask; and the merging unit is configured to: merge the first video feature and the second video feature to generate an input video feature for a next processing layer.

In this way, in the embodiments of the present disclosure, the plurality of processing layers in the video generation model are iterated to generate the video content, which may effectively ensure the correlation and accuracy between the first video feature and the selected object, and ensure the correlation between the second video feature and other objects and features other than the selected object, thereby ensuring the video quality of the generated video content.

In some embodiments, determining the first video feature based on the first mask, the plurality of image features, the audio content, and the preset first prompt information includes: performing a first attention processing process on an input video feature, the plurality of image features, and the first prompt information to generate a third video feature; and performing a second attention processing process on the third video feature, the first mask, and an audio feature of the audio content to generate the first video feature.

As an example, the input video feature may include the video token 321a shown in FIG. 3, the plurality of image features may refer to the plurality of reference tokens 321b shown in FIG. 3, and the first prompt information may be speaker prompt information, such as the “speak-text token” 321c shown in FIG. 3. The first mask may refer to the speaker mask sequence 302 shown in FIG. 3, and the audio feature may refer to the speak-audio token 304 shown in FIG. 3.

As an example, the first attention processing process may be a multimodal attention processing process, and the second attention processing process may be a cross-attention processing process.

In this way, the embodiments of the present disclosure are capable of accurately locating the speaking feature in the video feature through the first attention processing process, and obtaining the video feature corresponding to the speaker through the second attention processing process in combination with the mask feature corresponding to the selected object and the audio content, thereby ensuring the accuracy and effectiveness of the video feature corresponding to the speaker, and ensuring the correlation and accuracy between the audio content and the selected object in the motion content.

In some embodiments, determining the second video feature based on the second mask, the plurality of image features, and the preset second prompt information includes: performing a third attention processing process on an input video feature, the plurality of image features, and the second prompt information to generate a fourth video feature; and performing a fourth attention processing process on the fourth video feature and the second mask to generate the second video feature.

As an example, the input video feature may include the video token 322a shown in FIG. 3, the image feature may refer to the reference token 322b shown in FIG. 3, and the second prompt information may be listener prompt information, such as the “listen-text token” 322c shown in FIG. 3. The second mask may refer to the listener mask sequence 303 shown in FIG. 3, and the audio feature may refer to the listen-audio token 305 shown in FIG. 3.

In some embodiments, the third attention processing process may be a multimodal attention processing process, and the fourth attention processing process may be a cross-attention processing process.

In this way, the embodiments of the present disclosure are capable of accurately locating the listening feature in the video feature through the third attention processing process, and obtaining the video feature corresponding to the listener through the fourth attention processing process in combination with the second control signal, thereby ensuring the accuracy and effectiveness of the video feature corresponding to the listener, and ensuring that other objects than the selected object in the video content remain in the non-speaking state.

In some embodiments, the first prompt information indicates that the corresponding object is a speaking object; and/or the second prompt information indicates that the corresponding object is a non-speaking object.

In this way, in the embodiments of the present disclosure, by designating the object as the speaking object or the non-speaking object through the prompt information, the speaking state or the non-speaking state of the designated object in the generated video content may be effectively ensured, thereby quickly generating the video content of the designated person speaking.

### EXAMPLE APPARATUS AND DEVICE

The embodiments of the present disclosure also provide corresponding apparatuses for implementing the above methods or processes. FIG. 5 illustrates a schematic structural block diagram of an example apparatus 500 for video generation according to some embodiments of the present disclosure. The apparatus 500 may be implemented as or included in the electronic device 110. Each module/component in the apparatus 500 may be implemented by hardware, software, firmware, or any combination thereof.

As shown in FIG. 5, the apparatus 500 includes: a request receiving module 510 and a video providing module 520. The request receiving module 510 is configured to receive a video generation request, the video generation request being associated with a plurality of reference images corresponding to a plurality of objects, and the video generation request indicating a selection of at least one object from the plurality of objects; and the video providing module 520 is configured to provide video content generated based on the video generation request, the video content including background content and object content corresponding to the plurality of objects, the object content presenting a first motion associated with the selected at least one object, the first motion corresponding to audio content determined based on the video generation request, and the background content being generated based on the video generation request.

In some embodiments, the object content also presents a second motion associated with one or more objects of the plurality of objects, the second motion indicating a position change of the one or more objects in the scene.

In some embodiments, the video generation request indicates that the selected at least one object is a speaking object.

In some embodiments, the background content is generated based on first text content indicated by the video generation request.

In some embodiments, the apparatus 500 also includes an image determination module configured to: obtain a target image associated with the video generation request; identify the plurality of objects from the target image to determine a plurality of areas corresponding to the plurality of objects; and determine the plurality of reference images corresponding to the plurality of areas from the target image.

In some embodiments, the audio content includes: first audio content determined based on uploaded media content; or second audio content generated based on text content indicated by the video generation request.

In some embodiments, the video content is generated based on the following process: the electronic device 110 determines a plurality of image features corresponding to the plurality of reference images; determines a first mask corresponding to the at least one object; and generates, by a video generation model, the video content based on the plurality of image features, the first mask, and the audio content.

In some embodiments, determining the first mask corresponding to the at least one object includes: obtaining a video token and an object token corresponding to the at least one object; and determining, by a mask unit, the first mask corresponding to the at least one object based on the video token and the object token.

In some embodiments, determining the first mask corresponding to the at least one object further includes: updating, by the video generation model, the video token and the object token; and updating, by the mask unit, the first mask corresponding to the at least one object based on the updated video token and the updated object token.

In some embodiments, the video generation model includes a plurality of processing layers, each processing layer includes a first attention unit, a second attention unit, and a merging unit, where the first attention unit is configured to: determine a first video feature based on the first mask, the plurality of image features, the audio content, and preset first prompt information; the second attention unit is configured to: determine a second video feature based on a second mask, the plurality of image features, and preset second prompt information, the second mask being determined based on the first mask; and the merging unit is configured to: merge the first video feature and the second video feature to generate an input video feature for a next processing layer.

In some embodiments, determining the first video feature based on the first mask, the plurality of image features, the audio content, and the preset first prompt information includes: performing a first attention processing process on an input video feature, the plurality of image features, and the first prompt information to generate a third video feature; and performing a second attention processing process on the third video feature, the first mask, and an audio feature of the audio content to generate the first video feature.

In some embodiments, determining the second video feature based on the second mask, the plurality of image features, and the preset second prompt information includes: performing a third attention processing process on an input video feature, the plurality of image features, and the second prompt information to generate a fourth video feature; and performing a fourth attention processing process on the fourth video feature and the second mask to generate the second video feature.

In some embodiments, the third attention processing process may be a multimodal attention processing process, and the fourth attention processing process may be a cross-attention processing process.

In some embodiments, the first prompt information indicates that the corresponding object is a speaking object; and/or the second prompt information indicates that the corresponding object is a non-speaking object.

In the apparatus 500 provided by the embodiments of the present disclosure, for the specific processing procedure of each module and the technical effects brought about, reference may be made to the relevant description of the above example process 400, which will not be repeated herein.

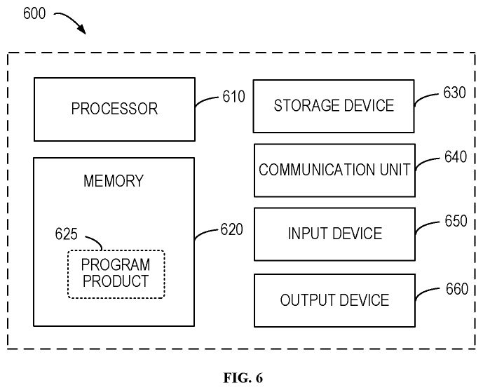

As shown in FIG. 6, the electronic device 600 is in the form of a general electronic device. The components of the electronic device 600 may include, but are not limited to, at least one processor 610 or processing unit, a memory 620, a storage device 630, one or more communication units 640, one or more input devices 650, and one or more output devices 660. The processor 610 may be an actual or virtual processor, and may execute various processing based on the program stored in the memory 620. In a multi-processor system, a plurality of processors execute computer-executable instructions in parallel, to improve the parallel processing capability of the electronic device 600.

The electronic device 600 typically includes a plurality of computer storage medium. Such medium may be any available medium that is accessible to the electronic device 600, including but not limited to volatile and non-volatile medium, removable and non-removable medium. The memory 620 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, it is possible to provide a disk driver for reading from or writing to a removable, non-volatile disk (such as a “floppy disk”), and an optical disk driver for reading from or writing to a removable, non-volatile optical disk. In these cases, each driver may be connected to the bus (not shown) by one or more data medium interfaces. The memory 620 may include a computer program product 625, which has one or more program modules configured to perform various methods or acts of various embodiments of the present disclosure.

The communication unit 640 implements communication with other electronic devices through the communication medium. Additionally, the functions of the components of the electronic device 600 may be implemented by a single computing cluster or a plurality of computing machines, which may communicate through a communication connection. Therefore, the electronic device 600 may use a logical connection with one or more other servers, a network personal computer (PC), or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) as needed through the communication unit 640, the external devices such as a storage device, a display device, etc., communicate with one or more devices that enable the user to interact with the electronic device 600, or communicate with any devices (for example, a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product, the computer program product is tangibly stored on a non-transitory computer-readable medium and includes computer-executable instructions, and the computer-executable instructions are executed by a processor to implement the method described above.

Various aspects of the present disclosure are described herein with reference to the flowcharts and/or block diagrams of the method, apparatus, device, and computer program product implemented according to the present disclosure. It should be understood that each block in the flowchart and/or block diagram, and a combination of various blocks in the flowchart and/or block diagram, may be implemented by computer-readable program instructions.

These computer-readable program instructions may be provided to a processor of a general-purpose computer, a special-purpose computer, or other programmable data processing apparatus to produce a machine, such that these instructions, when executed by the processor of the computer or other programmable data processing apparatus, produce an apparatus for implementing a function/act specified in one or more blocks in the flowchart and/or block diagram. These computer-readable program instructions may also be stored in a computer-readable storage medium, these instructions cause the computer, the programmable data processing apparatus, and/or other devices to work in a specific manner, and thus, the computer-readable medium having the instructions stored therein includes a manufactured product, which includes instructions for implementing various aspects of the function/act specified in one or more blocks in the flowchart and/or block diagram.

The computer-readable program instructions may be loaded onto a computer, other programmable data processing apparatus, or other devices, such that a series of operation steps are performed on the computer, other programmable data processing apparatus, or other devices to produce a computer-implemented process, so that the instructions executed on the computer, other programmable data processing apparatus, or other devices implement the function/act specified in one or more blocks in the flowchart and/or block diagram.

The flowchart and block diagram in the drawings show the possibly implemented architectures, functions, and operations of the system, method, and computer program product according to a plurality of implementations of the present disclosure. In this regard, each block in the flowchart or block diagram may represent a module, program segment, or part of an instruction, and the module, program segment, or part of an instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or the flowchart, and a combination of blocks in the block diagram and/or the flowchart may be implemented by a dedicated hardware-based system that executes specified functions or acts, or may be implemented by a combination of dedicated hardware and computer instructions.

The implementations of the present disclosure have been described above, and the above description is illustrative, non-exhaustive, and not limited to the disclosed implementations. Without departing from the scope and spirit of the described implementations, many modifications and changes will be apparent to those of ordinary skill in the art. The terms used herein are chosen to best explain the principles of the implementations, the practical applications, or improvements to the technology in the market, or to enable other persons of ordinary skill in the art to understand the various implementations disclosed herein.

1. A method for video generation, comprising:
receiving a video generation request, the video generation request being associated with a plurality of reference images corresponding to a plurality of objects, and the video generation request indicating a selection of at least one object from the plurality of objects; and
providing video content generated based on the video generation request, the video content comprising background content and object content corresponding to the plurality of objects, the object content presenting a first motion associated with the selected at least one object, the first motion corresponding to audio content determined based on the video generation request, and the background content being generated based on the video generation request.

2. The method of claim 1, wherein the object content further presents a second motion associated with one or more objects of the plurality of objects, the second motion indicating a position change of the one or more objects in a scene.

3. The method of claim 1, wherein the video generation request indicates that the selected at least one object is a speaking object.

4. The method of claim 1, wherein the background content is generated based on first text content indicated by the video generation request.

5. The method of claim 1, further comprising:
obtaining an image associated with the video generation request;
identifying the plurality of objects from the image to determine a plurality of areas corresponding to the plurality of objects; and
determining the plurality of reference images corresponding to the plurality of areas from the image.

6. The method of claim 1, wherein the audio content comprises:
first audio content determined based on uploaded media content; or
second audio content generated based on second text content indicated by the video generation request.

7. The method of claim 1, wherein the video content is generated based on a process of:
determining a plurality of image features corresponding to the plurality of reference images;
determining a first mask corresponding to the at least one object; and
generating, by a video generation model, the video content based on the plurality of image features, the first mask, and the audio content.

8. The method of claim 7, wherein the determining the first mask corresponding to the at least one object comprises:
obtaining at least one video token and at least one object token corresponding to the at least one object; and
determining, by a mask unit, the first mask corresponding to the at least one object based on the at least one video token and the at least one object token.

9. The method of claim 8, wherein the determining the first mask corresponding to the at least one object further comprises:
updating, by the video generation model, the at least one video token and the at least one object token; and
updating, by the mask unit, the first mask corresponding to the at least one object based on the updated at least one video token and the updated at least one object token.

10. The method of claim 7, wherein the video generation model comprises a plurality of processing layers, each of the processing layers comprises a first attention unit, a second attention unit, and a merging unit,
wherein the first attention unit is configured to: determine a first video feature based on the first mask, the plurality of image features, the audio content, and preset first prompt information;
the second attention unit is configured to: determine a second video feature based on a second mask, the plurality of image features, and preset second prompt information, the second mask being determined based on the first mask; and
the merging unit is configured to: merge the first video feature and the second video feature to generate an input video feature for a next processing layer.

11. The method of claim 10, wherein the determining the first video feature based on the first mask, the plurality of image features, the audio content, and the preset first prompt information comprises:
performing a first attention processing process on an input video feature, the plurality of image features, and the first prompt information to generate a third video feature; and
performing a second attention processing process on the third video feature, the first mask, and an audio feature of the audio content to generate the first video feature.

12. The method of claim 10, wherein the determining the second video feature based on the second mask, the plurality of image features, and the preset second prompt information comprises:
performing a third attention processing process on an input video feature, the plurality of image features, and the second prompt information to generate a fourth video feature; and
performing a fourth attention processing process on the fourth video feature and the second mask to generate the second video feature.

13. The method of claim 10, wherein at least one of:
the first prompt information indicates that a corresponding object is a speaking object;
the second prompt information indicates that a corresponding object is a non-speaking object.

14. An electronic device, comprising:
at least one processor; and
at least one memory, the at least one memory being coupled to the at least one processor and storing instructions for execution by the at least one processor, the instructions, when executed by the at least one processor, causing the electronic device to perform operations comprising:
receiving a video generation request, the video generation request being associated with a plurality of reference images corresponding to a plurality of objects, and the video generation request indicating a selection of at least one object from the plurality of objects; and
providing video content generated based on the video generation request, the video content comprising background content and object content corresponding to the plurality of objects, the object content presenting a first motion associated with the selected at least one object, the first motion corresponding to audio content determined based on the video generation request, and the background content being generated based on the video generation request.

15. The electronic device of claim 14, wherein the object content further presents a second motion associated with one or more objects of the plurality of objects, the second motion indicating a position change of the one or more objects in a scene.

16. The electronic device of claim 14, wherein the video generation request indicates that the selected at least one object is a speaking object.

17. The electronic device of claim 14, wherein the background content is generated based on first text content indicated by the video generation request.

18. The electronic device of claim 14, wherein the operations further comprise:
obtaining an image associated with the video generation request;
identifying the plurality of objects from the image to determine a plurality of areas corresponding to the plurality of objects; and
determining the plurality of reference images corresponding to the plurality of areas from the image.

19. The electronic device of claim 14, wherein the audio content comprises:
first audio content determined based on uploaded media content; or
second audio content generated based on second text content indicated by the video generation request.

20. A non-transitory computer-readable storage medium having computer-executable instructions stored thereon, the computer-executable instructions being executable by a processor to implement operations comprising:
receiving a video generation request, the video generation request being associated with a plurality of reference images corresponding to a plurality of objects, and the video generation request indicating a selection of at least one object from the plurality of objects; and
providing video content generated based on the video generation request, the video content comprising background content and object content corresponding to the plurality of objects, the object content presenting a first motion associated with the selected at least one object, the first motion corresponding to audio content determined based on the video generation request, and the background content being generated based on the video generation request.
